(19) United States
(12) Patent Application Publication
(10) Pub. No.: US 2015/0289711 A1
(43) Pub. Date: Oct. 15, 2015

(54) METHOD FOR PREPARING A FOAMED BEVERAGE

(71) Applicant: MARIUS WILLIE PIETER VENTER, Pretoria (ZA)

(72) Inventor: MARIUS WILLIE PIETER VENTER, Pretoria (ZA)

(21) Appl. No.: 14/251,753

(22) Filed: Apr. 14, 2014

(51) Int. Cl. A47J 31/44

(52) U.S. Cl. CPC A47J 31/4489

(57) ABSTRACT

A method for preparing a foamed beverage, the method comprising locating a milk-based substance in a holding container or foamer having at least one flexible wall portion and a closure to secure the milk-based substance in the holding container, the closure defining a spout, a tubular member in fluid communication with the milk-based substance and the spout, and at least one mixing chamber disposed between the spout and tubular member in which the milk-based substance and air can be mixed to form a dispersion; handling the holding container with milk-based substance therein and positioning same such that the spout is directed towards an open end of a drinking receptacle; and compressing, manually, the at least one flexible wall portion so as to increase air pressure within the holding container and actuate flow of milk-based substance and air located in the holding container via the tubular member to the mixing chamber to produce a milk-based substance and air dispersion, which upon further compression of the at least one flexible wall portion is forced to exit through the spout into the receptacle. The invention extends to a foamer used in such method.

THIS INVENTION relates generally to beverages and methods for preparation of beverages. In particular, the invention relates to a method for preparing a foamed beverage and to a foamer used in said method.

### BACKGROUND TO THE INVENTION

When nearly boiling water is forced under pressure through finely ground coffee beans a concentrated coffee-like beverage is produced. This concentrated beverage provides the basis for a Cappuccino, which further includes hot milk and steamed milk foam. Milk, being a colloid consisting of a solution of intermediate sized particles suspended and completely dispersed in a water-based fluid, is steamed to introduce tiny air bubbles into the milk thereby producing a foam which leaves the Cappuccino beverage with a velvety textured thick milk foam or froth layer on top.

Delivery nozzles of Cappuccino machines are operable to both rapidly heat up liquid flowing therethrough and create rising foam in a Cappuccino beverage, milk beverage, chocolate beverage and the like, by the admission of overheated steam. However, some of the nozzles of these machines are not able to produce dense and plentiful foam, while delivery nozzles of more complex machines are more difficult to clean and significantly more expensive.

Further, because of the complexity of some of these machines, the everyday user often finds it difficult to repair a defective machine and a technician is then required to attend to repair work with the consequence of increased downtime. In some instances, costly machine parts are required to be ordered from machine manufacturers, which further contribute to longer downtime periods.

In addition, the integrated coffee machines deal with rather large quantities of water, thus requiring some time for delivering steam, thereby adding to a quite cumbersome process of preparing a foamed beverage.

Where integrated coffee dispensing machines are not used to make foamed beverages such as, for example, Cappuccinos, battery-operated drink whisking devices are used. These devices usually operate at high rotating speeds and, as a result, their battery life is limited.

It is an object of the present invention to overcome, at least in part, the aforementioned drawbacks associated with known milk frothing machines.

A further object of the present invention is to provide a manually operated and simple to use milk frothing container which is easily cleanable and consequently reusable.

### SUMMARY OF THE INVENTION

According to the invention there is provided a method for preparing a foamed beverage, the method comprising:
locating a milk-based substance in a holding container or foamer having at least one flexible wall portion and a closure to secure the milk-based substance in a holding cavity of the holding container, the closure defining a spout, a tubular member in fluid communication with the milk-based substance and the spout, and at least one mixing chamber disposed between the spout and tubular member in which the milk-based substance and air can be mixed to form a dispersion;
handling the holding container with milk-based substance therein and positioning same such that the spout is directed towards an open end of a drinking receptacle; and
compressing, manually, the at least one flexible wall portion so as to increase air pressure within the holding container and actuate flow of milk-based substance and air located in the holding container via the tubular member to the mixing chamber to produce a milk-based substance and air dispersion, which upon further compression of the at least one flexible wall portion is forced to exit through the spout into the receptacle.

The method may include dispersing additional air into the milk-based substance and air dispersion, via at least one orifice defined in a floor of the mixing chamber by means of compression of the at least one flexible wall portion such that such additional air is drawn from the holding cavity into the mixing chamber to form an air enriched air-milk dispersion.

The method may further include forcing by manual compression either the milk-based substance and air dispersion or the air enriched dispersion passed at least one baffle means before same exits through the spout.

The method may also include forcing the milk-based substance and air dispersion or the air enriched dispersion through at least one mesh element before same exits through the spout.

The method further includes allowing the holding cavity to expand to its uncompressed state after compression of the flexible wall portion, which expansion occurs as a result of air being drawn back into the holding container via at least one air inlet provided in the closure. The method also allows for multiple cycles of compression and expansion to occur as a result of sequential press and release of the at least one flexible wall portion by a person using the foamer.

The method further provides for the milk-based substance to be heated prior to being located in the holding cavity and prior to manual compression of the at least one flexible wall portion.

The method may further include adding a flavorant to the milk-based substance in the holding container so that a flavored milk-based substance and air dispersion in the form of, for example chocolate milk, strawberry milkshake or cappuccino exits via the spout upon compression of the flexible wall portion. Alternatively, the method makes provision for a drinkable beverage to be located in the receptacle before the milk-based substance and air dispersion in the form of a froth or head of foam, which exits from the spout, is added to the drinkable beverage.

The invention extends to a foamer comprising:
a body, operable to be held by a person, defining a holding cavity in which a milk-based substance can be located, the body having at least one flexible wall portion;
a closure for the body to secure milk-based substance in the holding cavity;
a spout through which a foam, froth, air-milk dispersion or enriched air dispersion can exit;
a tubular member in fluid communication with both the spout and milk-based substance in the holding cavity; and
at least one mixing chamber disposed between the spout and tubular member in which the milk-based substance and air can be mixed upon depression of the at least one flexible wall portion to form an air-milk dispersion or enriched air dispersion in the form of a foam or froth.

There is also provided for the closure to have engagement means complementary shaped to a neck of the body and operatively mountable thereto.

There is further provided for the spout to be of unitary construction and integrally formed with the closure. Preferably, the spout has a beak defining a curvilinear internal fluid flow path.

In addition, provision is made for a floor of the mixing chamber to define at least one orifice through which air, operatively compressed within the holding cavity, can pass upon compression of the at least one flexible wall portion.

Moreover, provision is made for the foamer to comprise baffle means which is located between the tubular member and the spout in a flow path of an air-milk dispersion or in the flow path of an air enriched air milk dispersion created in the mixing chamber upon compression of the at least one flexible wall portion.

Furthermore, provision is made for the foamer to comprise at least one mesh element to be located between the tubular member and the spout in a flow path of an air-milk dispersion or in the flow path of an air enriched air milk dispersion created in the mixing chamber upon compression of the at least one flexible wall portion.

The invention also provides for the closure to have at least one air inlet through which ambient air can pass when air pressure within the holding cavity is lower than that of ambient air so as to effect expansion of the body after compression.

### BRIEF DESCRIPTION OF THE DRAWINGS

An embodiment of the invention is now described, by way of example, with reference to the accompanying non-limiting diagrammatic drawings. In the drawings:

FIG. 1 shows a perspective view of a foamer according to an embodiment of the invention;

FIG. 2 shows a schematic diagram which illustrates a method for preparing a foamed beverage in accordance with the invention;

FIG. 3 shows a perspective view of the foamer of FIG. 1 held by a person before a foamed beverage is prepared in accordance with the method of FIG. 2;

FIG. 4 shows the perspective view of the foamer of FIG. 1 immediately after manual compression thereof in accordance with a method of FIG. 2;

FIG. 5 shows an exploded perspective view of a closure, tubular member, and upper and lower portions, of a mixing chamber of the foamer of FIG. 1;

FIG. 6 shows an exploded perspective view of the upper and lower portions of the mixing chamber of FIG. 5;

FIG. 7 shows a longitudinal section view of the closure, tubular member, and connected upper and lower portions of the mixing chamber shown in FIG. 5;

FIG. 8 shows a top view of the connected upper and lower portions of the mixing chamber shown in FIG. 5; and

FIG. 9 shows a bottom view of the connected upper and lower portions of the mixing chamber shown in FIG. 5.

### DETAILED DESCRIPTION OF THE DRAWINGS

This description is presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how at least one of the several forms of the invention may be embodied in practice.

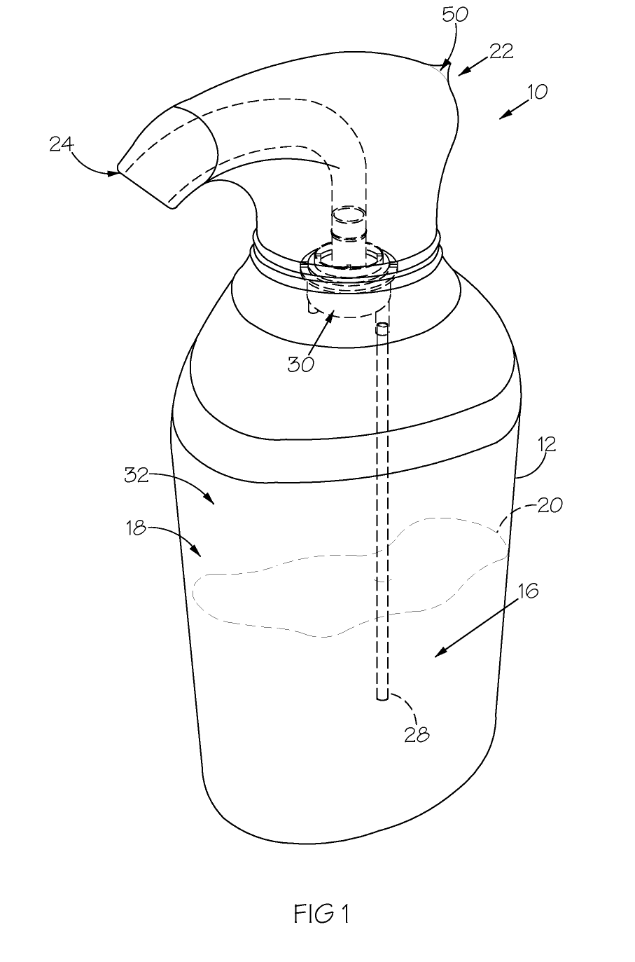

Turning now to FIG. 1 there is illustrated a perspective view of a foamer or froth providing container 10 in accordance with the invention.

Foamer 10 is particularly adapted to facilitate manual and swift production of a head of foam or froth on top of a beverage such as, for example, an Espresso so as to form a Cappuccino.

It is also envisaged that the method of the invention may be used to produce other foamed beverages such as foamy strawberry or chocolate milk drinks. It is further envisaged that any of a variety of milk types can be used to produce the foamed beverage. Such milk types include for example fully skimmed, semi-skimmed, whole fat, soya, and goat milk. The protein in milk, especially proteins such as casein and whey, are largely responsible for the foaming or frothing capacity in the milk. These proteins have the ability to denature and form a stabilizing film on the surface of the air bubbles in the foam.

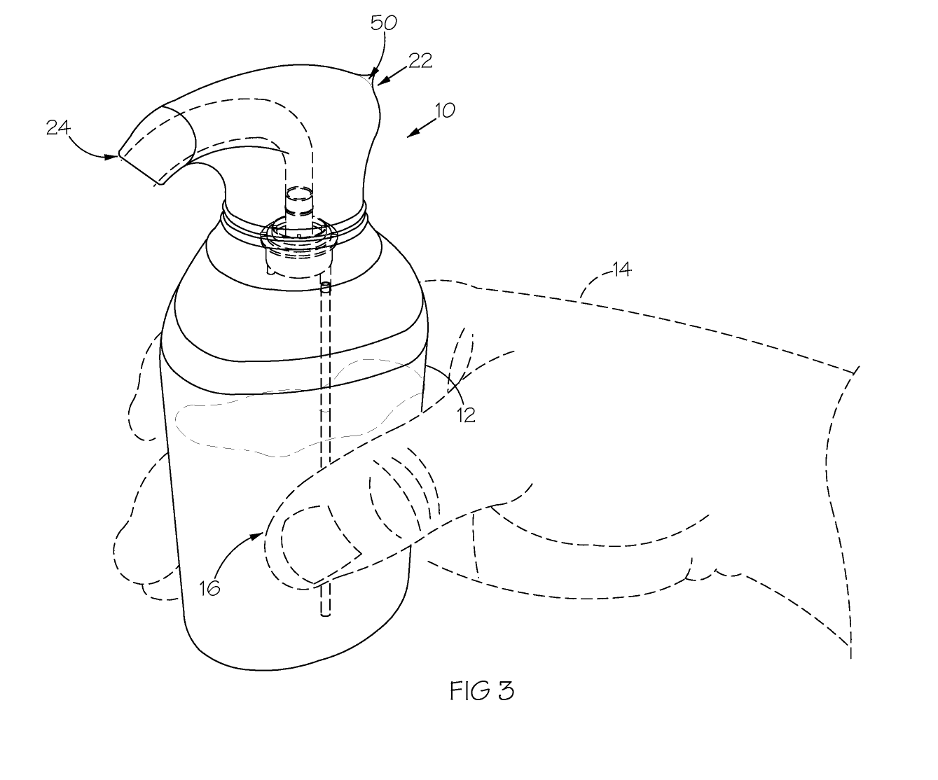

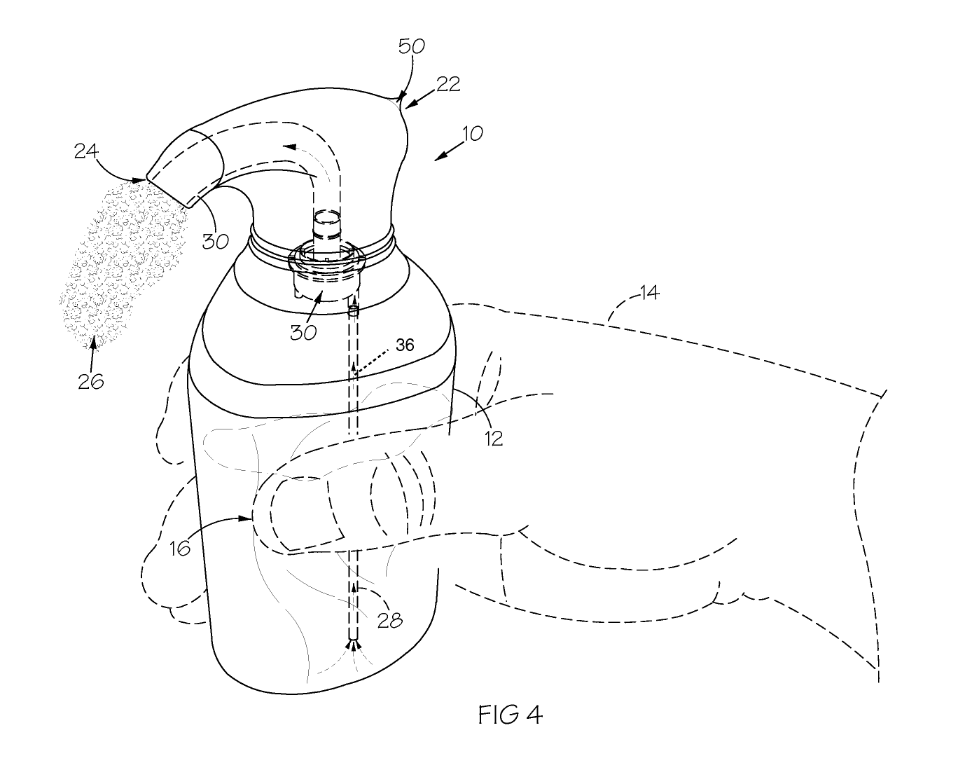

Foamer 10 may take a variety of shapes, but as shown in FIGS. 3 and 4 typically consists of a roughly rectangular container body 12, which can be grasped and held by a person in one hand 14, as shown in FIG. 3. Importantly, the body 12 comprises a flexible wall portion 16 and defines a holding cavity 18 in which milk 20 can be located. Foamer 10 also consists of a closure 22 for the body 12 to secure the milk 20 in the holding cavity 18. Foamer 10 further includes a spout 24 through which a froth or air-milk dispersion 26 can exit. A tubular member 28 is further provided for the foamer 10. The tubular member 28 is in fluid communication with both the spout 24 and the milk 20 in the holding cavity 18. In addition, the foamer 10 includes a mixing chamber 30 disposed between the spout 24 and tubular member 28 in which the milk 20 and cavity air 32 can be mixed upon depression of the flexible wall portion 16 to form the air-milk dispersion 26.

Although in this embodiment of the invention the flexible wall portion 16 is shown to include the entire elastic wall of the plastic foamer 10, it will be appreciated that in other embodiments of the invention, the flexible wall portion may take the form of a depressible tab or membrane (not shown) inserted or mounted into a rigid wall of the container, which tab is manually depressible to decrease the volume of the holding cavity and compress air located therein to initiate fluid flow from within the container towards the spout. In this embodiment, the entire elastic wall of the plastic foamer 10 may be manufactured from polyethylene terephthalate, or another suitable plastic.

It is also envisaged that in a further alternative embodiment of the invention, which is not shown, the flexible wall portion, instead of being in the form of a depressible tab or membrane, may comprise plunger means (not shown). The plunger means may be manually actuateable to decrease the volume of the holding cavity and compress air located therein to initiate fluid flow from within the container towards the spout.

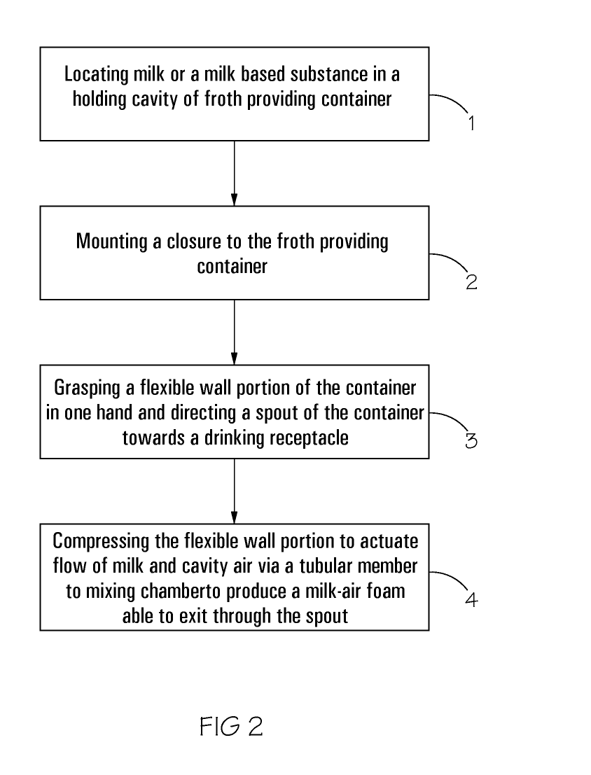

FIG. 2 shows a schematic diagram, which stepwise illustrates a method for preparing a foamed beverage in accordance with the invention.

According to step 1, the milk 20 is located in the holding cavity 18 of the foamer 10 whereafter, during step 2, the closure 22 is mounted to the foamer 10 to secure the milk therein. During step 3, the foamer 10, with the milk 20 therein, is grasped by a user in one hand and positioned such that the spout 24 of the closure 22 is directed towards a drinking receptacle such a cup (not shown). In step 4, the flexible wall portion 16 is manually compressed to increase air pressure within the holding cavity 18 and actuate flow of milk 20 and cavity air 32 via the tubular member 28 to the mixing chamber 30 to produce a milk-air dispersion 26 which upon further compression of the flexible wall portion 16 is forced to exit through the spout 24 into the receptacle.

Although not distinguishable from the drawings, the closure 22 includes engagement means in the form of an annular internal thread complementary shaped to a neck of the body 12 and operatively mountable thereto.

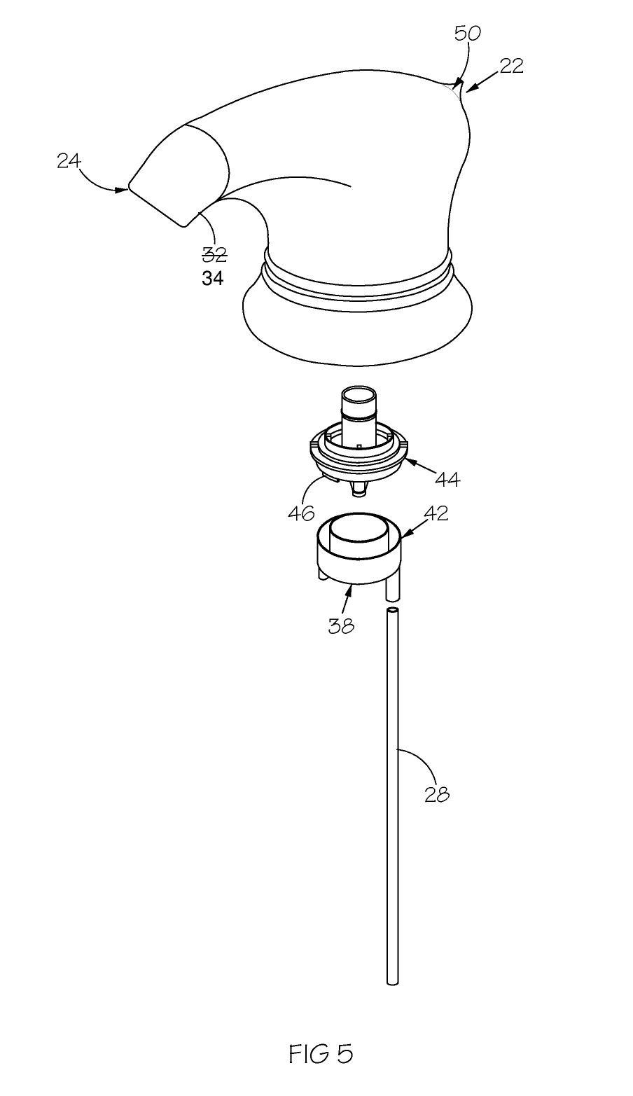

The spout 24 is typically, but not necessarily of unitary construction and integrally formed with the closure 22. As shown in FIG. 5, the spout 24 has a beak 34 which defines a curvilinear internal fluid flow path 36, best shown in FIG. 4, through which the milk-air dispersion 26 is operatively dispensed.

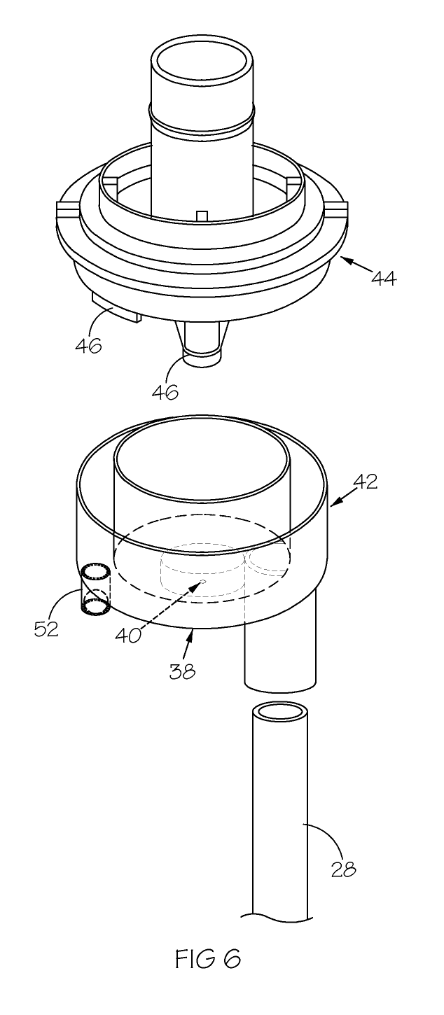

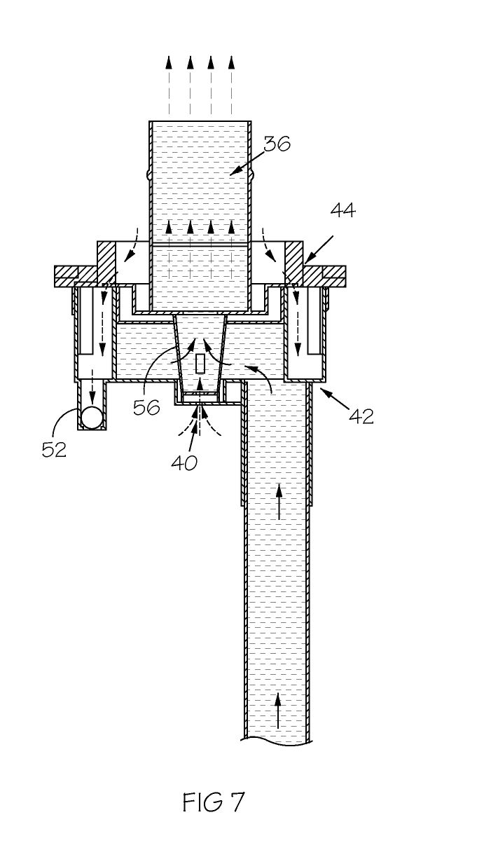

As illustrated in FIGS. 6 and 7, a floor 38 in an annular lower portion 42 of the mixing chamber 30 defines an orifice 40 through which cavity air 32, compressed within the holding cavity 18, can pass upon compression of the flexible wall portion 16. Cavity air 32 forced through orifice 40 joins air and milk 20, which are forced upwards through tubular member 28, in the mixing chamber 30 formed between the complementary shaped annular upper and lower mixing chamber portions 44, 42 to create an air enriched air-milk dispersion.

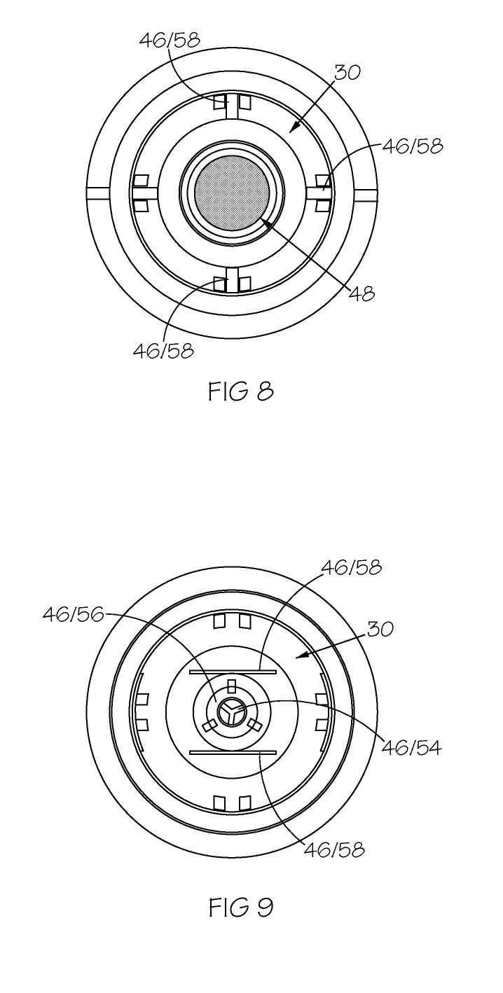

Baffle means 46 in the form of a y-shaped flow obstruction 54 (best shown in FIG. 9), an apertured conical element 56 (best shown in FIG. 7), and circumferentially spaced rectangular panels 58 (best shown in FIG. 8) are located between the tubular member 28 and the spout 24. In this embodiment of the invention, the baffle means 46 are provided in the upper portion 44 of the mixing chamber 30 and adapted to impede the flow of the air-milk dispersion 26 travelling via the tubular member 28 to the spout 24 when the flexible wall portion 16 is compressed. The baffle means 46 are, thus, flow-directing or obstructing vanes or panels used to promote mixing of the cavity air 32 with the air and milk 20, which are forced upwards through tubular member 28.

Furthermore, and as shown in FIG. 8, a mesh-like element 48 in the form of an interwoven or interlinked arrangement or construction is located between the tubular member 28 and the spout 24. The mesh-like element 48 defines a number of small openings through which air and the milk 20 operatively passes as it moves along the flow path 36. The air-milk dispersion 26 created upon compression of the flexible wall portion 16 becomes increasingly entrained with air as a result of forced movement of the air-milk dispersion 26 passed the baffle means 46 and the mesh-like element 48.

The closure 22, as shown in FIGS. 1, 3, and 4, also includes an air inlet 50. Ambient air passes through air inlet 50 when air pressure within the holding cavity 18 is lower than air pressure of the ambient air and as a result the body 12 expands again after compression. The air inlet 50 is also fluidly connected via a one way valve 52 with the holding cavity 18 and this connection is independent of the flow path 36.

The applicant believes that the foamer 10 and the method of using same in accordance with the present invention provides an inexpensive, simple, effective and easy to use alternative to existing ways in which foamed beverages are made.

1. A method for preparing a foamed beverage, the method comprising:
locating a milk-based substance in a holding container or foamer having at least one flexible wall portion and a closure to secure the milk-based substance in the holding container, the closure defining a spout, a tubular member in fluid communication with the milk-based substance and the spout, to and at least one mixing chamber disposed between the spout and tubular member in which the milk-based substance and air can be mixed to form a dispersion;
handling the holding container with milk-based substance therein and positioning same such that the spout is directed towards an open end of a drinking receptacle; and
compressing, manually, the at least one flexible wall portion so as to increase air pressure within the holding container and actuate flow of milk-based substance and air located in the holding container via the tubular member to the mixing chamber to produce a milk-based substance and air dispersion, which upon further compression of the at least one flexible wall portion is forced to exit through the spout into the receptacle.

2. The method of claim 1, including dispersing additional air into the milk-based substance and air dispersion, via at least one orifice defined in a floor of the mixing chamber by means of compression of the at least one flexible wall portion so that such additional air is drawn into the mixing chamber to form an air enriched dispersion.

3. The method as claimed in claim 2, further including forcing by manual compression either the milk-based substance and air dispersion or the air enriched dispersion passed at least one baffle means before same exits through the spout.

4. The method as claimed in claim 2, further including forcing by manual compression either the milk-based substance and air dispersion or the air enriched dispersion through at least one mesh element before same exits through the spout.

5. The method as claimed in claim 2, including allowing the holding container or foamer having milk-based substance therein to expand to its uncompressed state after compression of the flexible wall portion, which expansion occurs as a result of ambient air being drawn back into the holding container via at least one air inlet provided in the closure.

6. The method as claimed in claim 5, wherein multiple cycles of compression and expansion are effected by sequential press and release of the at least one flexible wall portion by a person using the foamer.

7. The method as claimed in claim 6, wherein the milk-based substance is heated prior to manual compression of the flexible wall portion.

8. A foamer comprising:
a body, operable to be held by a person, defining a holding cavity in which a milk-based substance can be located, the body having at least one flexible wall portion;
a closure for the body to secure milk-based substance in the holding cavity;
a spout through which a foam, froth, air-milk dispersion or enriched air dispersion can exit;
a tubular member in fluid communication with both the spout and milk-based substance in the holding cavity; and
at least one mixing chamber disposed between the spout and tubular member in which the milk-based substance and air can be mixed upon depression of the at least one flexible wall portion to form an air-milk dispersion or enriched air dispersion in the form of a foam or froth.

9. The foamer as claimed in claim 8, wherein the spout is of unitary construction and integrally formed with the closure.

10. The foamer as claimed in claim 9, wherein the spout comprises a beak defining a curvilinear internal fluid flow path.

11. The foamer as claimed in claim 10, wherein a floor of the mixing chamber defines at least one orifice through which air, compressed within the holding cavity, can pass upon compression of the at least one flexible wall portion.

12. The foamer as claimed in claim 11, wherein baffle means is located between the tubular member and the spout in a flow path of an air-milk dispersion or in the flow path of an air enriched air milk dispersion created in the mixing chamber upon compression of the at least one flexible wall portion.

13. The foamer as claimed in claim 11, wherein at least one mesh element is located between the tubular member and the spout in a flow path of an air-milk dispersion or in the flow path of an air enriched air milk dispersion created in the mixing chamber upon compression of the at least one flexible wall portion.

14. The foamer as claimed in claim 11, wherein the closure comprise at least one air inlet through which ambient air can pass when air pressure within the holding cavity is lower than that of ambient air so as to effect expansion of the body after compression.
